(19) United States
(12) Patent Application Publication
(10) Pub. No.: US 2022/0074349 A1
(43) Pub. Date: Mar. 10, 2022

(54) SPLIT COMPRESSOR GAS TURBINE ENGINE

(71) Applicant: PRATT & WHITNEY CANADA CORP., Longueuil (CA)

(72) Inventors: Patrick VALOIS, Longueuil (CA); Hervé TURCOTTE, Sainte-Julie (CA); Ghislain PLANTE, Verdun (CA)

(21) Appl. No.: 17/014,051

(22) Filed: Sep. 8, 2020

(51) Int. Cl. F02C 7/36; F02C 7/32

(52) U.S. Cl. CPC F02C 7/36; F02C 7/275; F02C 7/32

(57) ABSTRACT

A turboprop or turboshaft gas turbine engine includes a low pressure turbine drivingly engaged to an output shaft for driving a rotatable load. A low pressure compressor is de-coupled from the low pressure turbine, the low pressure compressor and turbine rotating independently from one another. A high pressure compressor is disposed downstream from the low pressure compressor and is in fluid communication therewith to receive pressurized air therefrom. A high pressure turbine is disposed downstream from the high pressure compressor and is drivingly engaged thereto via a high pressure shaft. The high pressure turbine is disposed upstream from the low pressure turbine and is in fluid communication therewith. An electric motor receives power from a power source, is drivingly engaged to the low pressure compressor, and is operable to drive the low pressure compressor independently from the low pressure turbine, the high pressure compressor and the high pressure turbine.

### TECHNICAL FIELD

The present disclosure relates generally to a turboshaft or turboprop gas turbine engine for an aircraft, and, more particularly, to such a gas turbine engine having a split compressor.

### BACKGROUND

To improve performance and efficiency, gas turbine engines such as turboprop engines or turboshaft engines may be provided with multiple spools, such as a low pressure spool which may include a low pressure compressor (LPC) and is driven by a low pressure turbine (LPT), and a high pressure spool including a high pressure compressor (HPC) driven by a high pressure turbine (HPT). The LPC may also include a “boost stage” which provides an initial compression of intake air before the air is directed further downstream within the engine. In such “boosted” engines, the LPC is typically driven by the LPT through a low pressure (LP) shaft, and the HPC is driven by the HPT through a high pressure (HP) shaft. The LP shaft is typically concentric with and internal to a hollow HP shaft.

In such traditional “boosted” engines, the operability of the LPC is dependent on the LPT due to their connection via the LP shaft. As such, the LPC cannot be driven independently at a desired regime. In addition, for example in a turboprop gas turbine engine, the ratio between the LPT speed and the propeller speed in certain conditions could cause operability challenges on the LPC.

### SUMMARY

In one aspect, there is provided a turboprop or turboshaft gas turbine engine comprising a low pressure turbine drivingly engaged to an output shaft for driving a rotatable load, a low pressure compressor de-coupled from the low pressure turbine, the low pressure compressor and the low pressure turbine rotating independently from one another, a high pressure compressor disposed downstream from the low pressure compressor and in fluid communication therewith to receive pressurized air therefrom, a high pressure turbine disposed downstream from the high pressure compressor and drivingly engaged thereto via a high pressure shaft, the high pressure turbine disposed upstream from the low pressure turbine and in fluid communication therewith, and an electric motor receiving power from a power source and drivingly engaged to the low pressure compressor, the electric motor operable to drive the low pressure compressor independently from the low pressure turbine, the high pressure compressor and the high pressure turbine.

In another aspect, there is provided a turboprop or turboshaft gas turbine engine comprising a low pressure assembly including a low pressure compressor decoupled from a low pressure turbine, the low pressure compressor and the low pressure turbine rotating independently from one another, a high pressure spool including a high pressure compressor disposed downstream from the low pressure compressor and in fluid communication therewith to receive pressurized air therefrom, and a high pressure turbine disposed downstream from a combustor and the high pressure compressor, the high pressure turbine drivingly engaged to the high pressure compressor via a high pressure shaft, the high pressure turbine disposed upstream from the low pressure turbine and in fluid communication therewith, an output shaft drivingly engaged to the low pressure turbine and operable to drivingly engage a rotatable load, and means for driving the low pressure compressor independently from the low pressure turbine, the high pressure compressor and the high pressure turbine, the means including an electric motor.

In a further aspect, there is provided a method of operating a gas turbine engine, comprising drawing air into a core of the gas turbine engine through a low pressure compressor and then through a high pressure compressor to provide pressurized air, igniting a mixture of the pressurized air and fuel to generate combustion gases, directing the combustion gases through a high pressure turbine and then through a low pressure turbine to drive the high pressure turbine and the low pressure turbine with the combustion gases, driving the high pressure compressor with the high pressure turbine via a high pressure shaft, and selectively driving the low pressure compressor with an electric motor drivingly engaged to the low pressure compressor.

Further in accordance with the third aspect, for instance, the method further comprises driving a rotatable load with the low pressure turbine.

Further in accordance with the third aspect, for instance, selectively driving the low pressure compressor further includes the electric motor directly driving the low pressure compressor.

Further in accordance with the third aspect, for instance, selectively driving the low pressure compressor further includes the electric motor driving the low pressure compressor via a gear system in an accessory gearbox.

Further in accordance with the third aspect, for instance, the method further comprises powering the electric motor via a secondary power unit and/or a battery pack.

Further in accordance with the third aspect, for instance, the method further comprises powering the electric motor via a generator driven by the gas turbine engine.

Further in accordance with the third aspect, for instance, the generator is driven via an accessory gearbox by one of the high pressure shaft or the output shaft.

Further in accordance with the third aspect, for instance, the method further comprises generating electrical power by deactivating a power source powering the electric motor and operating the electric motor as a generator driven by the low pressure compressor.

### BRIEF DESCRIPTION OF THE DRAWINGS

Reference is now made to the accompanying figures in which:

FIG. 1 is a schematic cross sectional view of a gas turbine engine, according to an embodiment of the present disclosure;

FIG. 2 is a schematic cross sectional view of the gas turbine engine of FIG. 1 with a clutch between the electric motor and the low pressure compressor;

FIG. 3 is a schematic cross sectional view of the gas turbine engine of FIG. 1 with a clutch between the electric motor and the low pressure compressor and a clutch between the electric motor and the high pressure shaft;

FIG. 4 is a schematic cross sectional view of the gas turbine engine of FIG. 1 with the electric motor directly driving the low pressure compressor;

FIG. 5 is a schematic cross sectional view of a gas turbine engine, according to an additional embodiment of the present disclosure;

FIG. 6 is a schematic cross sectional view of the gas turbine engine of FIG. 5 with a clutch between the electric motor and the low pressure compressor;

FIG. 7 is a schematic cross sectional view of the gas turbine engine of FIG. 5 with a clutch between the electric motor and the low pressure compressor and a clutch between the electric motor and the high pressure shaft;

FIG. 8 is a schematic cross sectional view of the gas turbine engine of FIG. 5 with the electric motor directly driving the low pressure compressor;

FIG. 9 is a schematic cross sectional view of the gas turbine engine of FIG. 5 with the external load positioned towards an aft portion of the engine;

FIGS. 10A-10C are block diagrams showing various power sources for the gas turbine engine of FIG. 1; and

FIGS. 11A-110 are block diagrams showing various power sources for the gas turbine engine of FIG. 5.

### DETAILED DESCRIPTION

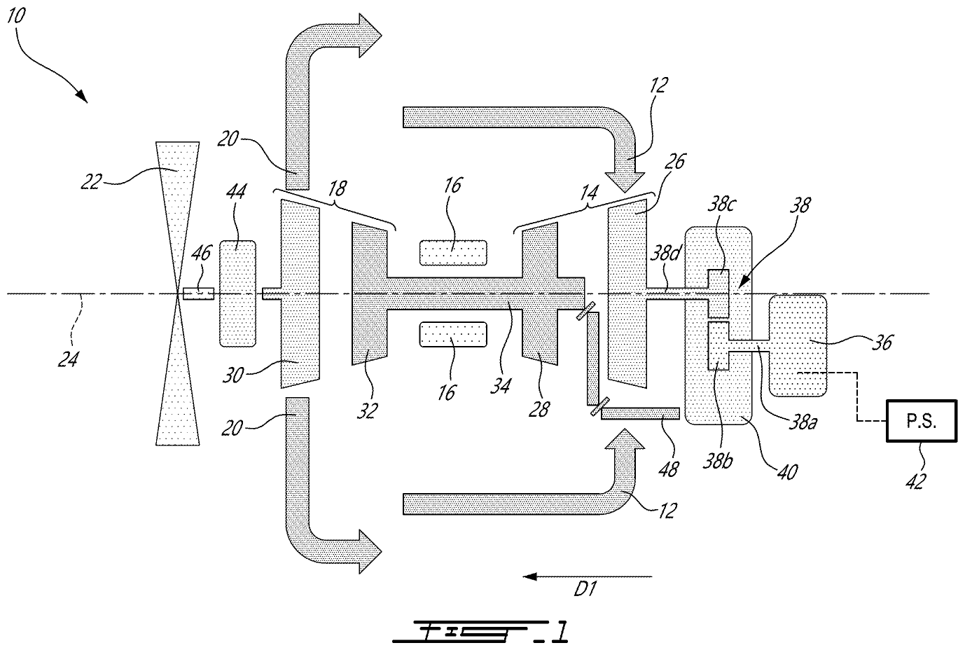

FIG. 1 illustrates a turboprop gas turbine engine 10 of a type preferably provided for use in subsonic flight, generally comprising in serial flow communication an air inlet 12, a compressor section 14 for pressurizing the air from the air inlet 12, a combustor 16 in which the compressed air is mixed with fuel and ignited for generating an annular stream of hot combustion gases, a turbine section 18 for extracting energy from the combustion gases, and an exhaust outlet 20 through which the combustion gases exit the gas turbine engine 10. The engine 10 may include an external load such as a propeller 22 which provides thrust for flight and taxiing. The gas turbine engine 10 includes a longitudinal center axis 24.

The gas turbine engine 10 (sometimes referred to herein simply as “engine 10”) shown in FIG. 1 has a “reverse-flow” engine configuration because gases flow through it from the air inlet 12 at an aft portion thereof, to the exhaust outlet 20 at a forward portion thereof. The terms “forward” and “aft”, used in this context, are understood to be with reference to the direction of travel of the aircraft. This is in contrast to a standard “through-flow” gas turbine engine configuration, in which gases flow through the engine from a forward portion to an aft portion. Such “through-flow” gas turbine engine configurations will be discussed in further detail below. In the “reverse-flow” engine 10 of FIG. 1, the direction of the flow of gases through the core of the engine 10 can be better appreciated by considering that the gases flow in the same direction D1 as the one along which the aircraft, and thus the engine 10 mounted thereto, travels during flight. Stated differently, gases flow through the engine 10 from an aft end thereof towards the propeller 16.

It will thus be appreciated that the expressions “forward” and “aft” used herein refer to the relative disposition of components of the engine 10, in correspondence to the “forward” and “aft” directions of the engine 10 and aircraft including the engine 10 as defined with respect to the direction of travel. In the embodiment shown, a component of the engine 10 that is “forward” of another component is arranged within the engine 10 such that it is located closer to the front of the engine 10, illustratively towards propeller 22. Similarly, a component of the engine 10 that is “aft” of another component is arranged within the engine 10 such that it is further away from the front of the engine 10, illustratively further away from propeller 22. The expressions “forward” and “aft” refer to the same relative directions in later discussed embodiments, regardless of the direction of travel of gasses through the engine 10 or the presence or absence of propeller 22.

It will also be appreciated that the expressions “upstream” and downstream” used herein refer to the relative disposition of components of the engine 10 with reference to the direction D1 of gas flow passing through the engine 10, regardless of their relative forward or aft positioning. For instance, in the “reverse-flow” engine 10 shown in FIG. 1, the compressor section 14 is positioned upstream of the combustor 16 and the turbine section 18. Alternatively, in a “through-flow” engine configuration, as will be discussed in further detail below, the upstream and downstream relative positioning of components will generally correspond to their relative forward and aft positioning.

Still referring to FIG. 1, the compressor section 14 and the turbine section 16 are operable to, respectively, compress and extract energy from the airflow in multiple stages. The compressor section 14 includes a low pressure compressor 26 (sometimes referred to as “LPC 26”) and a high pressure compressor 28 (sometimes referred to as “HPC 28”), while the turbine section 18 includes a low pressure turbine 30 (sometimes referred to as “LPT 30”) and a high pressure turbine 32 (sometimes referred to as “HPT 32”). The HPC 28 and HPT 32 are drivingly engaged via a high pressure shaft 34. In the shown case, the LPC 26, HPC 28, LPT 30, HPT 32 and the high pressure shaft 34 are each collinear with the longitudinal center axis 24. As such, the HPC 28 and HPT 32 may be referred to as a high pressure spool, as the HPT 32 rotatably drives the HPC 28 via the high pressure shaft 34 to compress the flowing airflow.

Conversely, in the architecture of the engine 10, the LPC 26 is decoupled from the LPT 30 and is thus not driven by the LPT 30. Rather, the LPC 26 is driven by an electric motor 36, as will be discussed in further detail below. Illustratively, when viewing the engine 10 of FIG. 1 in the direction D1 of airflow, the LPC 26 is upstream of the HPC 28, both of which are downstream of the air inlet 12 and upstream of the combustor 16. The HPT 32 is downstream of the combustor 16 and upstream of the LPT 30, which is upstream of the exhaust outlet 20. Other configurations may be considered as well. In the illustrated case, as there is no low pressure shaft joining the LPC 26 to the LPT 30 (as there would be in a typical multi-stage gas turbine engine), there is no need to ensure that concentric low and high pressure shafts do not interfere with one another. The LPC 26 and LPT 30 are thus said to be “de-coupled” from each other.

It can therefore be appreciated that the presence of the above-described LPC 26, HPC 28, LPT 30 and HPT 32 provides the engine 10 with a “split compressor” arrangement, wherein the LPC 26 and the HPC 28 are independently rotatable and thus capable of being driven at different speeds. More particularly, some of the work required to compress the incoming air is transferred from the HPC 28 to the LPC 26. This transfer of work may contribute to higher pressure ratios while maintaining a relatively small number of rotors. In a particular embodiment, higher pressure ratios allow for higher power density, better engine specific fuel consumption (SFC), and a lower turbine inlet temperature for a given power. These factors can contribute to a lower overall weight for the engine 10. The transfer of compression work from the HPC 28 to the LPC 26 contrasts with some conventional reverse-flow engines, in which the high pressure compressor (and thus the high pressure turbine) perform most of the compression work.

In light of the preceding, it can be appreciated that the LPT 30 may be considered “low pressure” turbine when compared to the HPT 32, which is sometimes referred to as forming part of the “gas generator”. The de-coupled LPT 30 may also be referred to as a “power turbine”. The turbine rotors of the HPT 32 may spin at a higher rotational speed than the turbine rotors of the LPT 30, for instance given the closer proximity of the HPT 32 to the outlet of the combustor 16. In addition, the LPC 26 and HPC 28 may be driven at different rotational speeds to maximize efficiency. For instance, the compressor rotors of the HPC 28 may rotate at a higher rotational speed than the compressor rotors of the LPC 26.

In the embodiment shown in FIG. 1, the electric motor 36 is drivingly engaged to the LPC 26 via a gear system 38, which in the present embodiment is a gear system forming part of an accessory gearbox 40. By connecting the electric motor 36 to the LPC 26 using the gear system 38, the operational speeds of the LPC 26 and the electric motor 36 are permitted to differ, i.e. they use one or more shafts and gears to harmonize their respective rotational speeds. In addition, the accessory gearbox 40 receives a rotational output and in turn drives accessories (e.g. fuel pump, starter-generator, oil pump, scavenge pump, etc.) that contribute to the functionality of the engine 10. In other cases, the electric motor 36 may drivingly engage the LPC 26 differently, including directly (i.e. without any intermediary gear system therebetween), as will be discussed in further detail below. The electric motor 36 receives power from a power source 42 (sometimes referred to as “P.S. 42”). As will be discussed in further detail below, various power sources may be considered for power source 42.

Illustratively, the gear system 38 includes a shaft 38a exiting the electric motor 36 with a first gear 38b mounted to a distal end thereof. The first gear 38b is drivingly engaged with a second gear 38c mounted to a distal end of a shaft 38d drivingly engaged to the LPC 26. In other cases, the gear system 38 may include different numbers of gears and/or shafts.

As the LPC 26 is decoupled from the LPT 30, it is capable of being selectively operated (i.e. driven) by electric motor 36 independently from the LPT 30, the HPC 28 and the HPT 32. In such a case, the boost pressure delivered to the HPC 28 by the LPC 26 may be independently modulated as needed. In addition, in conditions where little to no boost is needed from the LPC 26 (i.e. an LPC 26 pressure ratio of around 1.0), the power source for the electric motor 36 may be shut off and the LPC 26 may be left to freely rotate via the flowing airflow (i.e. “windmilling”) to rotatably drive the electric motor 36 and act as a generator to provide additional electrical power for various engine 10 or aircraft needs. In the shown embodiment, although not necessarily the case in all embodiments, the LPT 30, decoupled from the LPC 26, is operable to rotatably drive the external load 22 via a reduction gearbox 44 and an output shaft 46. In the shown case, the output shaft 46 is collinear with the longitudinal axis 24. The LPT 30 may thus be referred to as a “free turbine” or a “power turbine”, as discussed above, as it only powers the external load 22, for instance a propeller or a helicopter blade.

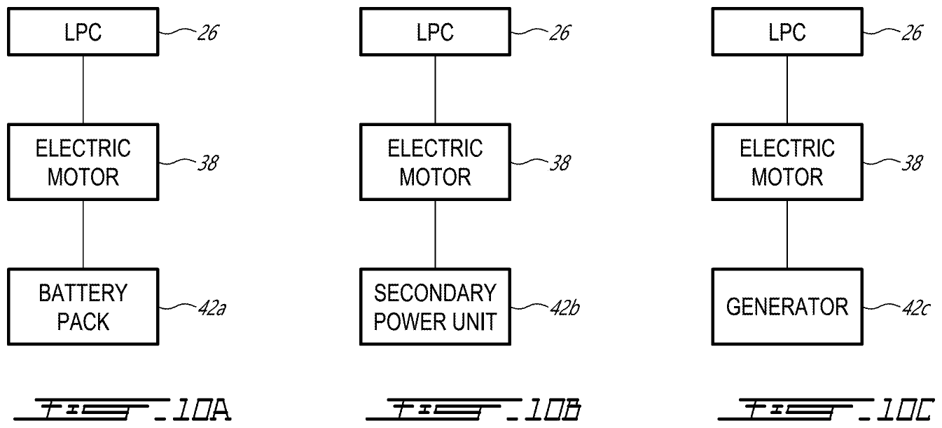

Referring additionally to FIGS. 10A-10C, as discussed above, the power required to drive the electric motor 36 may originate from a variety of sources. In various cases, the power source 42 providing such power may be a battery pack 42a, a secondary power unit 42b, or in some cases the engine 10 itself. For instance, in such latter cases the electric motor 36 may be powered by a generator 42c driven by the high pressure shaft 34 via one or more additional shafts 48, illustratively two additional shafts, via the accessory gearbox 40. Alternatively, such a generator 42c may be driven by the output shaft 46. Other configurations for generating and storing power for the electric motor 36 may be considered as well. Of note, for simplicity, any elements connecting the electric motor 36 to the LPC 26 (for instance, gearbox 38 within accessory gearbox 40) are omitted from FIGS. 10A-10C.

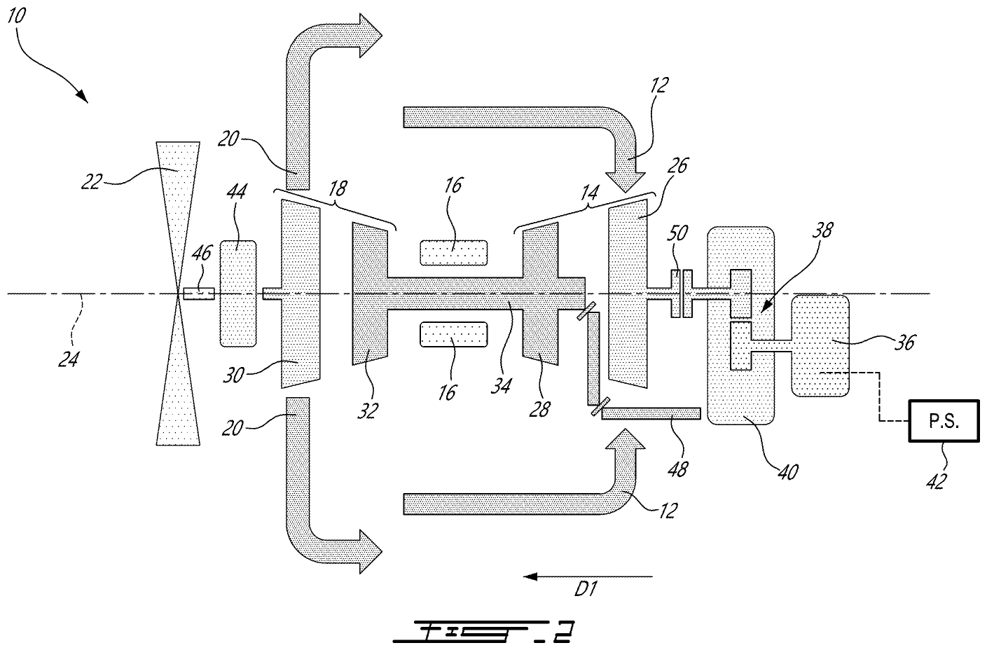

Referring now to FIG. 2, an alternate embodiment of the engine 10 of FIG. 1 is shown, with like reference numerals referring to like elements. In the shown case, a low pressure clutch 50 is installed between the electric motor 36 and the LPC 26. Other coupling/decoupling devices may be considered as well. As such, in operating conditions where little or no boost from the LPC 26 is required (and the LPC 26 is not being used to generate power for the electric motor 36, as discussed above), the low pressure clutch 50 may be disengaged to decouple the electric motor 36 from the LPC 26, thus reducing the drag of driving the LPC 26. The low pressure clutch 50 may then be re-engaged to re-couple the electric motor 36 to the LPC 26 as conditions dictate.

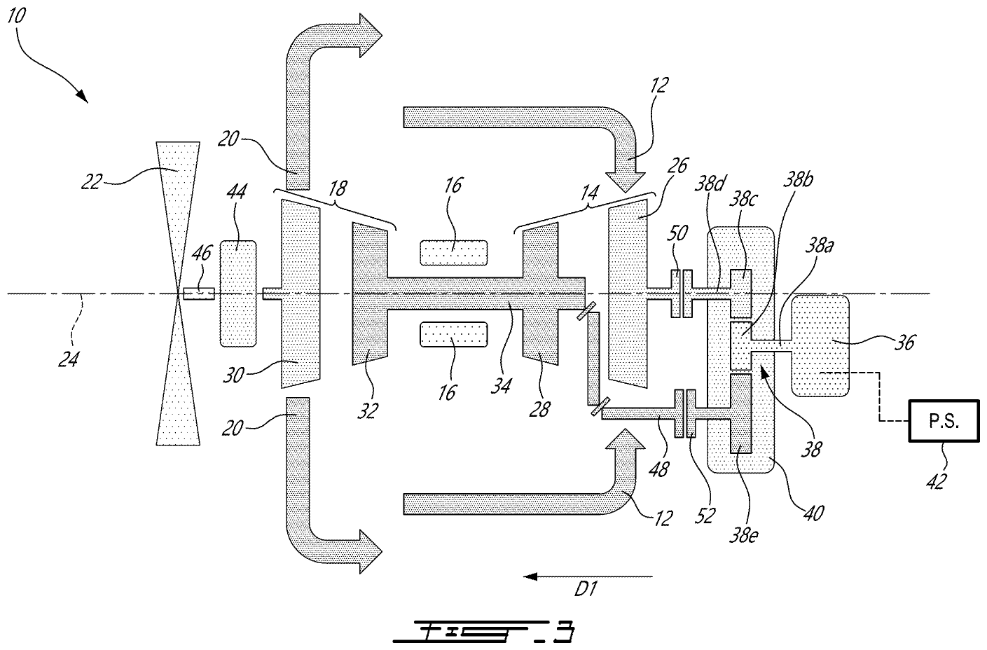

Referring now to FIG. 3, another alternate embodiment of the engine 10 of FIGS. 1 and 2 is shown, with like reference numerals referring to like elements. In the shown case, a high pressure clutch 52 (other coupling/decoupling devices may be considered as well) connects the high pressure shaft 34, illustratively via the additional shafts 48, to the electric motor 36, additionally through a third gear 38e in the accessory gearbox 40. As such, both the low pressure clutch 50 and high pressure clutch 52 may be individually engaged and/or disengaged as conditions dictate. In certain cases, the low pressure clutch 50 may be disengaged (thus decoupling the electric motor 36 from the LPC 26) and the high pressure clutch 52 may be engaged (thus coupling the electric motor 36 to the high pressure shaft 34), thereby allowing the electric motor 36 to act as an engine starter for the engine 10. Similarly, in such an arrangement the electric motor 36 may act as a generator driven by the high pressure spool, thus generating electrical power for various engine or aircraft needs.

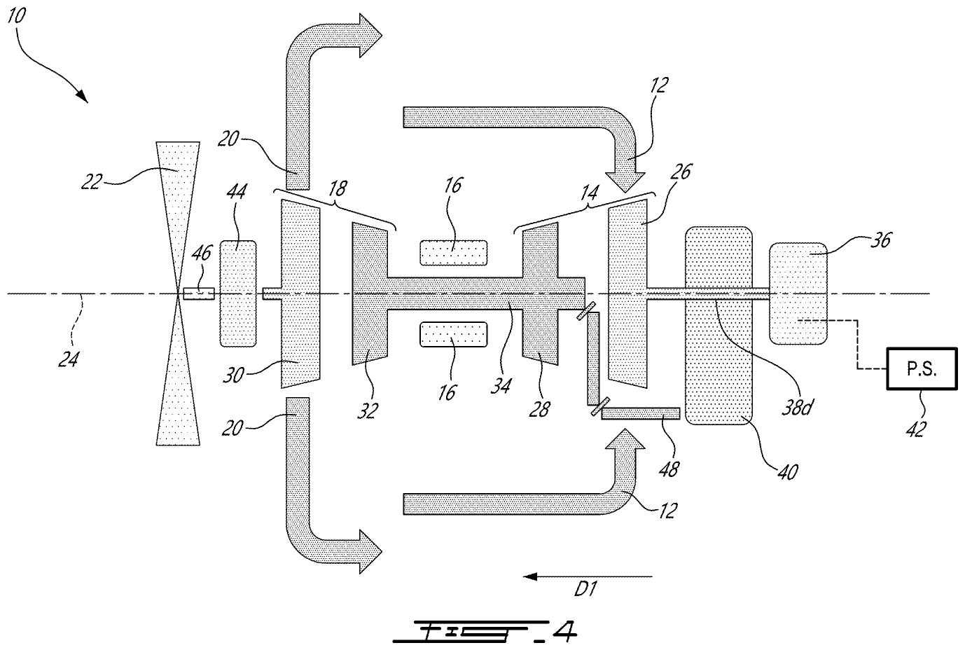

Referring now to FIG. 4, another alternate embodiment of the engine 10 of FIGS. 1-3 is shown, with like reference numerals referring to like elements. In the shown case, the operating speeds of the LPC 26 and the electric motor 36 are compatible, i.e. the accessory gearbox 40 does not require a series of gears to rotatably connect the LPC 26 to the electric motor 36. Rather, the LPC 26 is directly driven by the electric motor 36, for instance via shaft 38d. In such cases, the rotational speed outputted by the electric motor 36 would match the rotational speed of the shaft 38d driving the LPC 26.

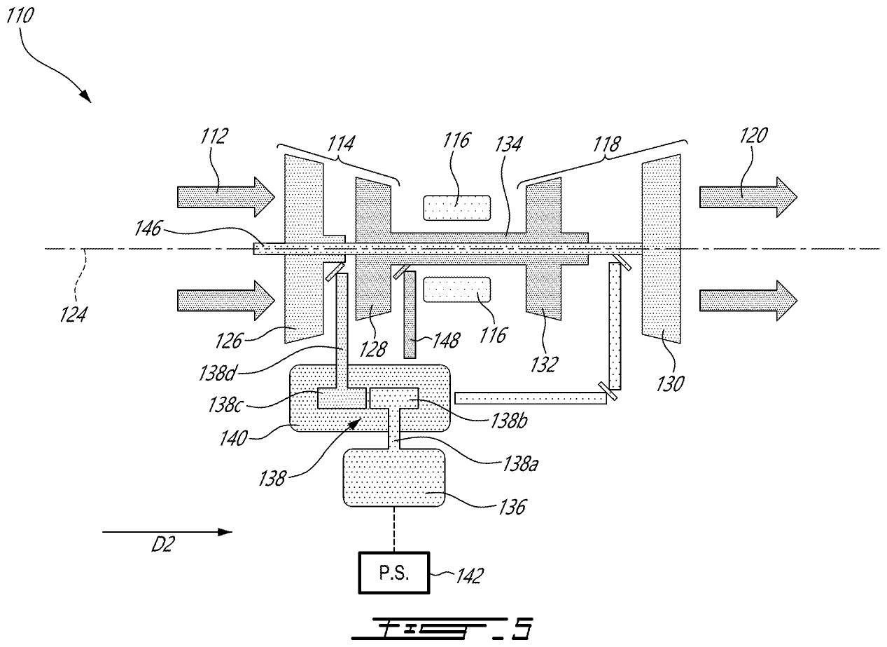

Referring now to FIG. 5, an additional embodiment for an engine 110 having a through-flow configuration is shown. Similarly to FIG. 1, FIG. 5 illustrates a turboshaft gas turbine engine 110 of a type preferably provided for use in subsonic flight, generally comprising in serial flow communication an air inlet 112, a compressor section 114 for pressurizing the air from the air inlet 112, a combustor 116 in which the compressed air is mixed with fuel and ignited for generating an annular stream of hot combustion gases, a turbine section 118 for extracting energy from the combustion gases, and an exhaust outlet 120 through which the combustion gases exit the gas turbine engine 110. The engine 110 may be operable to drive an external load (not shown). The gas turbine engine 110 has a longitudinal center axis 124.

The gas turbine engine 110 (sometimes referred to herein simply as “engine 110”) shown in FIG. 5 is a “through-flow” engine because gases flow through it from the air inlet 112 at a forward portion thereof, to the exhaust outlet 120 at an aft portion thereof, i.e. along direction D2 in FIG. 5. This is in contrast to “reverse-flow” gas turbine engines shown in FIGS. 1-4.

The compressor section 114 and the turbine section 118 are operable to, respectively, compress and extract energy from the airflow in multiple stages. The compressor section 114 includes a low pressure compressor 126 (sometimes referred to as “LPC 126”) and a high pressure compressor 128 (sometimes referred to as “HPC 128”), while the turbine section 118 includes a low pressure turbine 130 (sometimes referred to as “LPT 130”) and a high pressure turbine 132 (sometimes referred to as “HPT 132”). The HPC 128 and HPT 132 are drivingly engaged via a high pressure shaft 134. In the shown case, the LPC 126, HPC 128, LPT 130, HPT 132 and the high pressure shaft 134 are each collinear with the longitudinal center axis 124. As such, the HPC 128 and HPT 132 may be referred to as a high pressure spool, as the HPT 132 rotatably drives the HPC 128 via the high pressure shaft 134 to compress the flowing airflow.

Conversely, in the architecture of the engine 10, the LPC 126 is decoupled from the LPT 130 and is thus not driven by the LPT 130. Rather, the LPC 126 is driven by an electric motor 136, as will be discussed in further detail below. Illustratively, when viewing the engine 110 of FIG. 5 in the direction D of airflow, the LPC 126 is upstream of the HPC 128, both of which are downstream of the air inlet 112 and upstream of the combustor 116. The HPT 132 is downstream of the combustor 116 and upstream of the LPT 130, which is upstream of the exhaust outlet 120. Other configurations may be considered as well. The LPC 126 and LPT 130 are thus said to be “de-coupled” from each other.

It can therefore be appreciated that the presence of the above-described LPC 126, HPC 128, LPT 130 and HPT 132 provides the engine 110 with a “split compressor” arrangement, wherein the LPC 126 and the HPC 128 are independently rotatable and thus capable of being driven at different speeds. More particularly, some of the work required to compress the incoming air is transferred from the HPC 128 to the LPC 126. This transfer of work may contribute to higher pressure ratios while maintaining a relatively small number of rotors. In a particular embodiment, higher pressure ratios allow for higher power density, better engine specific fuel consumption (SFC), and a lower turbine inlet temperature for a given power. These factors can contribute to a lower overall weight for the engine 110. The transfer of compression work from the HPC 128 to the LPC 126 contrasts with some conventional reverse-flow engines, in which the high pressure compressor (and thus the high pressure turbine) perform most of the compression work.

In light of the preceding, it can be appreciated that the LPT 130 may be considered the “low pressure” turbine when compared to the HPT 132, which is sometimes referred to as forming part of the “gas generator”. The de-coupled LPT 130 may also be referred to as a “power turbine”. The turbine rotors of the HPT 132 may spin at a higher rotational speed than the turbine rotors of the LPT 130, for instance given the closer proximity of the HPT 132 to the outlet of the combustor 116. In addition, the LPC 126 and the HPC 128 may be driven at different rotational speeds to maximize efficiency. For instance, the compressor rotors of the HPC 128 may rotate at a higher rotational speed than the compressor rotors of the LPC 126.

In the embodiment shown in FIG. 5, the electric motor 136 is drivingly engaged to the LPC 126 via a gear system 138, which in the present embodiment is a gear system forming part of an accessory gearbox 140. By connecting the electric motor 136 to the LPC 126 using the gear system 138, the operational speeds of the LPC 126 and the electric motor 136 are permitted to differ, i.e. they use one or more shafts and gears to harmonize their respective rotational speeds. In addition, the accessory gearbox 140 receives a rotational output and in turn drives accessories (e.g. fuel pump, starter-generator, oil pump, scavenge pump, etc.) that contribute to the functionality of the engine 110. In other cases, the electric motor 136 may drivingly engage the LPC 126 differently, including directly (i.e. without any intermediary gear system therebetween), as will be discussed in further detail below. The electric motor 136 receives power from a power source 142. As will be discussed in further detail below various power sources may be considered for power source 142.

Illustratively, the gear system 138 includes a shaft 138a exiting the electric motor 136 with a first gear 138b mounted to a distal end thereof. The first gear 138b is drivingly engaged with a second gear 138c mounted to a distal end of a shaft 138d drivingly engaged to the LPC 126. In other cases, the gear system 138 may include different numbers of gears and/or shafts.

As the LPC 126 is decoupled and from the LPT 130, it is capable of being selectively operated (i.e. driven) by electric motor 136 independently from the LPT 130, the HPC 128 and the HPT 132. In such a case, the boost pressure delivered to the HPC 128 by the LPC 126 may be independently modulated as needed. In addition, in conditions where little to no boost is needed from the LPC 126 (i.e. an LPC 126 pressure ratio of around 1.0), the power source for the electric motor 136 may be shut off and the LPC 126 may be left to freely rotate via the flowing airflow (i.e. “windmilling”) to rotatably drive the electric motor 136 and act as a generator to provide additional electrical power for various engine 110 or aircraft needs. In the shown embodiment, although not necessarily the case in all embodiments, the LPT 130, decoupled from the LPC 126, is operable to rotatably drive the external load (not shown) via an output shaft 146. In the shown case, the output shaft 146 is collinear with the longitudinal axis 124, the external load (not shown) is positioned towards the “forward” of the engine 110 (i.e. upstream of the compressor section 114) and thus the output shaft 146 passes through the high pressure shaft 134 and the LPC 126. The LPT 130 may thus be referred to as a “free turbine” or a “power turbine” as it only powers the external load.

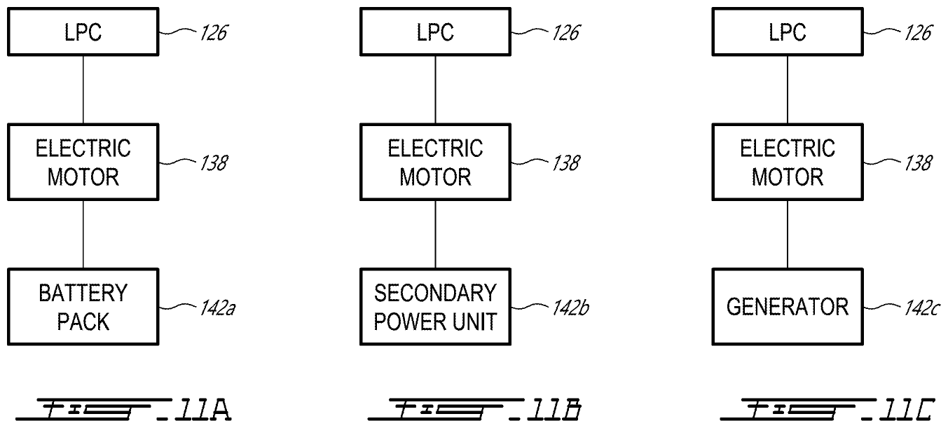

Referring additionally to FIGS. 11A-11C, as discussed above, the power required to drive the electric motor 136 may originate from a variety of sources. In various cases, the power source 142 providing such power may come from a battery pack 142a, a secondary power unit 142b, or in some cases from the engine 110 itself. For instance, in such latter cases the electric motor 136 may be powered by a generator 142c driven by the high pressure shaft 134 via one or more additional shafts 148, illustratively one additional shaft, via the accessory gearbox 140. Alternatively, such a generator 142c may be driven by the output shaft 146. Other configurations for generating and storing power for the electric motor 136 may be considered as well. Of note, for simplicity, any elements connecting the electric motor 136 to the LPC 126 (for instance, gearbox 138 within accessory gearbox 140) are omitted from FIGS. 11A-11C.

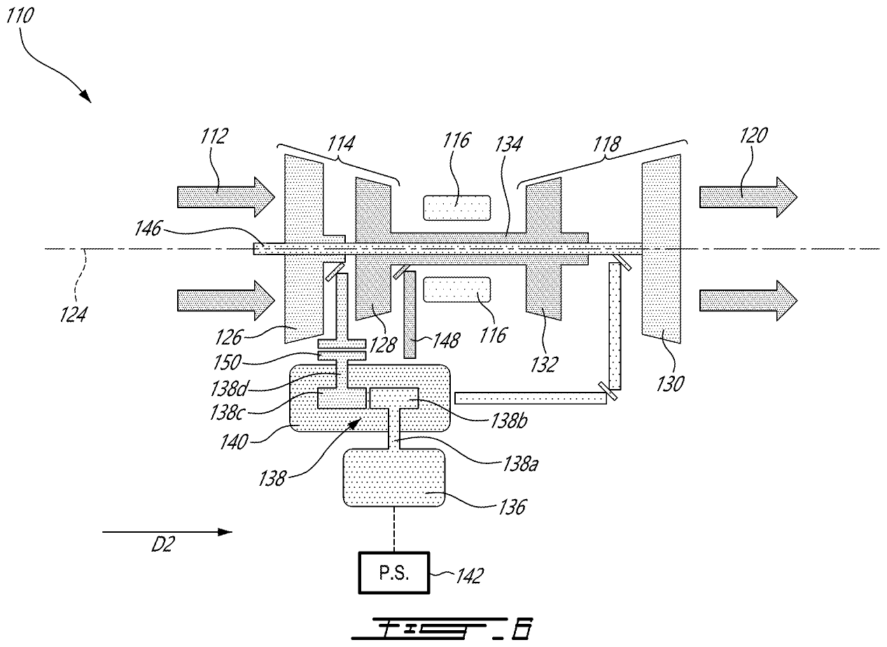

Referring now to FIG. 6, an alternate embodiment of the engine 110 of FIG. 5 is shown, with like reference numerals referring to like elements. In the shown case, a low pressure clutch 150 is installed between the electric motor 136 and the LPC 126. Other coupling/decoupling devices may be considered as well. As such, in operating conditions where little or no boost from the LPC 126 is required (and the LPC 126 is not being used to generate power for the electric motor 136, as discussed above), the low pressure clutch 150 may be disengaged to decouple the electric motor 136 from the LPC 126, thus reducing the drag of driving the LPC 126. The low pressure clutch 150 may then be re-engaged to re-couple the electric motor 136 to the LPC 126 as conditions dictate.

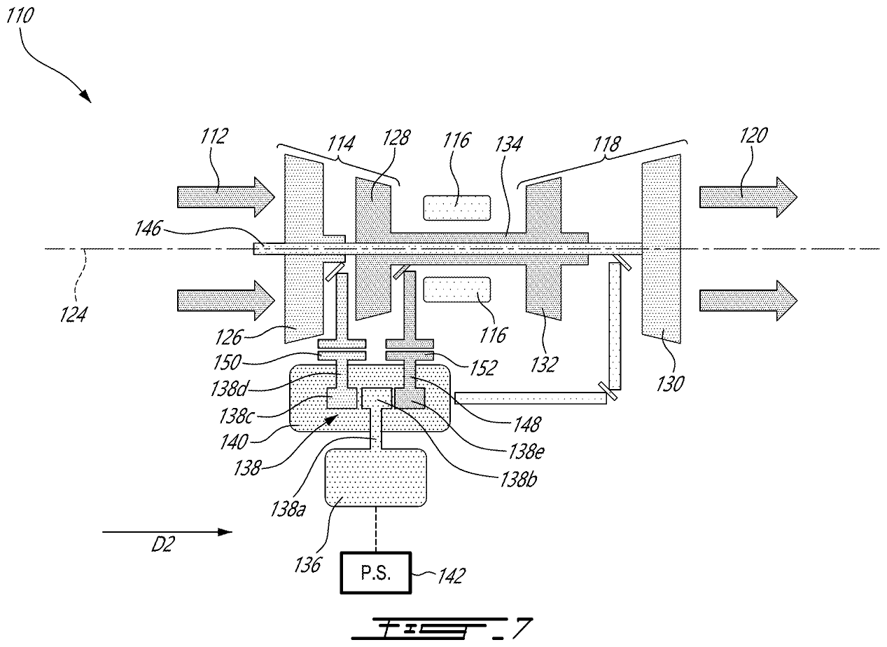

Referring now to FIG. 7, another alternate embodiment of the engine 110 of FIGS. 5 and 6 is shown, with like reference numerals referring to like elements. In the shown case, a high pressure clutch 152 (other coupling/decoupling devices may be considered as well) connects the high pressure shaft 134, illustratively via the additional shaft 148, to the electric motor 136, additionally through a third gear 138e in the accessory gearbox 140. As such, both the low pressure clutch 150 and high pressure clutch 152 may be individually engaged and/or disengaged as conditions dictate. In certain cases, the low pressure clutch 150 may be disengaged (thus decoupling the electric motor 136 from the LPC 126) and the high pressure clutch 152 may be engaged (thus coupling the electric motor 136 to the high pressure shaft 134), thereby allowing the electric motor 136 to act as an engine starter for the engine 110. Similarly, in such an arrangement the electric motor 136 may act as a generator driven by the high pressure spool, thus generating electrical power for various engine or aircraft needs.

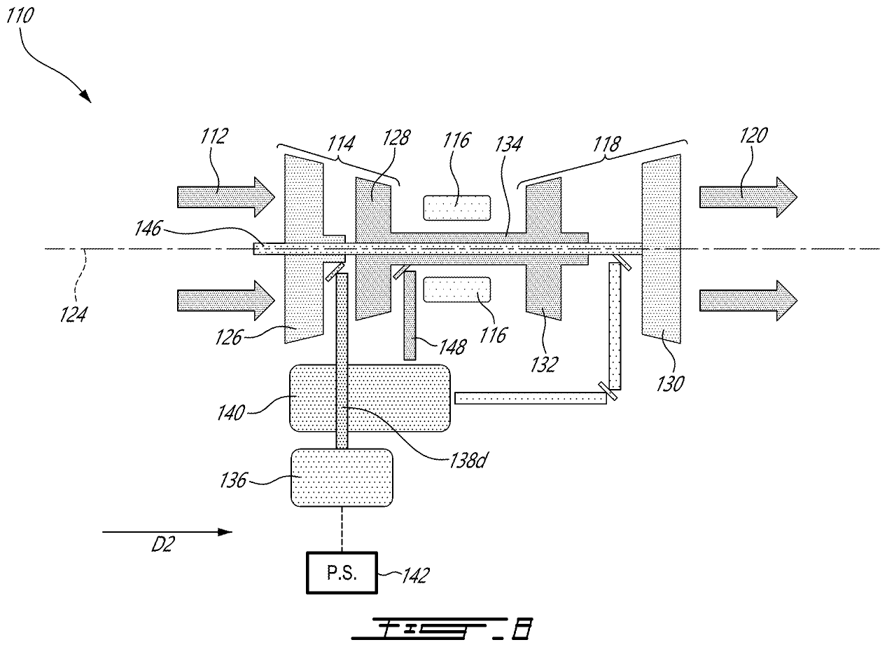

Referring now to FIG. 8, another alternate embodiment of the engine 110 of FIGS. 5-7 is shown, with like reference numerals referring to like elements. In the shown case, the operating speeds of the LPC 126 and the electric motor 136 are compatible, i.e. the accessory gearbox 140 does not require a series of gears to rotatably connect the LPC 126 to the electric motor 136. Rather, the LPC 126 is directly driven by the electric motor 136, for instance via shaft 138d.

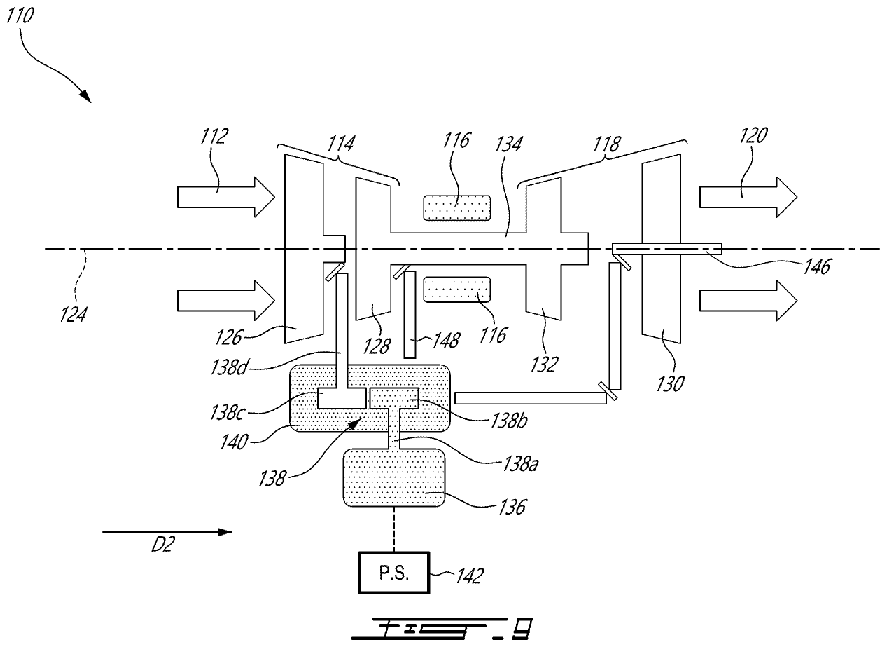

Referring now to FIG. 9, another alternate embodiment of the engine 110 of FIGS. 5-8 is shown, with like reference numerals referring to like elements. In such an embodiment, the external load (not shown) may be positioned towards the aft portion of the engine 110. As such, the output shaft 146 would similarly be positioned towards the aft portion of the engine 110. In the illustrated case, as there is no low pressure shaft joining the LPC 126 to the LPT 130 (as there would be in a typical multi-stage gas turbine engine), there is no need to ensure that concentric low and high pressure shafts do not interfere with one another.

Although FIGS. 1-4 show an engine 10 with a reverse-flow, turboprop configuration while FIGS. 5-9 show an engine 110 with a through-flow, turboshaft configuration, other configurations may be considered as per the present technology. For instance, a through-flow, turboprop engine configuration may be considered. Alternatively, a reverse-flow, turboshaft engine configuration may be considered as well.

It can be appreciated that various means are contemplated for transferring rotational power from the electric motor 36, 136 to the LCP 26, 126 to drive the LPC 26, 126 independently from the LPT 30, 130, the HPC 28, 128 and the HPT 32, 132. As mentioned herein above, in some cases the electric motor 36, 136 may drive the LPC 26, 126 through a gear system 38, 138. The gear system 38, 138 may be within an accessory gearbox 40, 140 of the gas turbine engine 10, 110, the gear system 38, 138 including a first shaft 38a, 138a rotatably connected to the electric motor 36, 136 with a first gear 38b, 138b mounted to a distal end thereof, and a second shaft 38d, 138d rotatably connected to the LPC 26, 126 having a second gear 38c, 138c mounted to a distal end thereof, the first gear 38b, 138b drivingly engaged with the second gear 38c, 138c. In other cases, the electric motor 36, 136 may drive the LPC 26, 126 directly, i.e. without any intermediary gear system therebetween. Other means for transferring rotational power from the electric motor 36, 136 to the LPC 26, 126 may be contemplated as well.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A turboprop or turboshaft gas turbine engine comprising:
a low pressure turbine drivingly engaged to an output shaft for driving a rotatable load;
a low pressure compressor de-coupled from the low pressure turbine, the low pressure compressor and the low pressure turbine rotating independently from one another;
a high pressure compressor disposed downstream from the low pressure compressor and in fluid communication therewith to receive pressurized air therefrom;
a high pressure turbine disposed downstream from the high pressure compressor and drivingly engaged thereto via a high pressure shaft, the high pressure turbine disposed upstream from the low pressure turbine and in fluid communication therewith; and
an electric motor receiving power from a power source and drivingly engaged to the low pressure compressor, the electric motor operable to drive the low pressure compressor independently from the low pressure turbine, the high pressure compressor and the high pressure turbine.

2. The gas turbine engine as defined in claim 1, wherein the low pressure compressor is directly driven by the electric motor.

3. The gas turbine engine as defined in claim 1, wherein the low pressure compressor is driven by the electric motor through a gear system.

4. The gas turbine engine as defined in claim 3, wherein the gear system is within an accessory gearbox of the gas turbine engine, the gear system including a first shaft rotatably connected to the electric motor with a first gear mounted to a distal end thereof, and a second shaft rotatably connected to the low pressure compressor having a second gear mounted to a distal end thereof, the first gear drivingly engaged with the second gear.

5. The gas turbine engine as defined in claim 1, wherein the power source includes a secondary power unit and/or a battery pack.

6. The gas turbine engine as defined in claim 1, wherein the power source includes a generator driven by the gas turbine engine.

7. The gas turbine engine as defined in claim 6, wherein the generator is driven via an accessory gearbox by one of the high pressure shaft or the output shaft.

8. The gas turbine engine as defined in claim 1, wherein the gas turbine engine is a reverse flow gas turbine engine or a through flow gas turbine engine.

9. The gas turbine engine as defined in claim 1, further comprising a first clutch operably connecting the electric motor to the low pressure compressor, the first clutch selectively disengageable under low boost requirements to reduce drag on the gas turbine engine by decoupling the electric motor from the low pressure compressor.

10. The gas turbine engine as defined in claim 9, further comprising a second clutch operably connecting the electric motor and the high pressure shaft, wherein the electric motor is operable to, while the second clutch is engaged and the first clutch is disengaged, at least one of start the gas turbine engine via the high pressure shaft or operate as a generator driven by the high pressure shaft.

11. A turboprop or turboshaft gas turbine engine comprising:
a low pressure assembly including a low pressure compressor decoupled from a low pressure turbine, the low pressure compressor and the low pressure turbine rotating independently from one another;
a high pressure spool including a high pressure compressor disposed downstream from the low pressure compressor and in fluid communication therewith to receive pressurized air therefrom, and a high pressure turbine disposed downstream from a combustor and the high pressure compressor, the high pressure turbine drivingly engaged to the high pressure compressor via a high pressure shaft, the high pressure turbine disposed upstream from the low pressure turbine and in fluid communication therewith;
an output shaft drivingly engaged to the low pressure turbine and operable to drivingly engage a rotatable load; and
means for driving the low pressure compressor independently from the low pressure turbine, the high pressure compressor and the high pressure turbine, said means including an electric motor.

12. The gas turbine engine as defined in claim 11, wherein the means for driving the low pressure compressor independently from the low pressure turbine, the high pressure compressor and the high pressure turbine further include the electric motor directly driving the low pressure compressor.

13. The gas turbine engine as defined in claim 11, wherein the means for driving the low pressure compressor independently from the low pressure turbine, the high pressure compressor and the high pressure turbine further include the electric motor driving the low pressure compressor through a gear system.

14. The gas turbine engine as defined in claim 13, wherein the gear system is within an accessory gearbox of the gas turbine engine, the gear system including a first shaft rotatably connected to the electric motor with a first gear mounted to a distal end thereof, and a second shaft rotatably connected to the low pressure compressor having a second gear mounted to a distal end thereof, the first gear drivingly engaged with the second gear.

15. The gas turbine engine as defined in claim 11, wherein the means for driving the low pressure compressor independently from the low pressure turbine, the high pressure compressor and the high pressure turbine further include powering the electric motor via a secondary power unit and/or a battery pack.

16. The gas turbine engine as defined in claim 11, wherein the means for driving the low pressure compressor independently from the low pressure turbine, the high pressure compressor and the high pressure turbine further include powering the electric motor via a generator driven by the gas turbine engine.

17. The gas turbine engine as defined in claim 16, wherein the generator is driven via an accessory gearbox by the high pressure shaft or the output shaft.

18. The gas turbine engine as defined in claim 11, further comprising means for decoupling the electric motor from the low pressure compressor to reduce drag on the gas turbine engine, said means including disengaging a first clutch operably connecting the electric motor to the low pressure compressor under low boost requirements.

19. The gas turbine engine as defined in claim 18, further comprising means for starting the gas turbine engine via the electric motor and the high pressure shaft, said means including disengaging the first clutch and engaging a second clutch operably connecting the electric motor and the high pressure shaft.

20. The gas turbine engine as defined in claim 18, further comprising means for operating the gas turbine engine as a generator via the electric motor and the high pressure shaft, said means including disengaging the first clutch and engaging a second clutch operably connecting the electric motor and the high pressure shaft.
